(19) United States
(12) Patent Application Publication
(10) Pub. No.: US 2023/0085245 A1
(43) Pub. Date: Mar. 16, 2023

(54) SYSTEMS AND METHODS OF BROADBAND ACHROMATIC METASURFACE WAVEPLATES

(71) Applicant: PRESIDENT AND FELLOWS OF HARVARD COLLEGE, Cambridge, MA (US)

(72) Inventors: Xinghui YIN, Cambridge, MA (US); Federico CAPASSO, Cambridge, MA (US)

(73) Assignee: PRESIDENT AND FELLOWS OF HARVARD COLLEGE, Cambridge, MA (US)

(21) Appl. No.: 17/940,993

(22) Filed: Sep. 8, 2022

Related U.S. Application Data
(60) Provisional application No. 63/242,932, filed on Sep. 10, 2021.

(51) Int. Cl. G02B 1/00

(52) U.S. Cl. CPC G02B 1/007

(57) ABSTRACT

Disclosed is a broadband achromatic metasurface waveplate including a device that includes a plurality of nanostructures physically coupled to a substrate and formed at least partially of a dielectric material having a first refractive index and an anti-reflective film applied to a surface of the device. The anti-reflective film may include a material having a second refractive index that is less than the first refractive index. The device and the anti-reflective film may modify incident light with wavelengths extending over a bandwidth of at least 100 nanometers to impart a substantially uniform phase retardation across the wavelengths and a transmittance of at least 90 percent across the wavelengths.

### CROSS-REFERENCE TO RELATED APPLICATIONS

This application claims the benefit of and priority to U.S. Provisional Patent Application 63/242,932, filed Sep. 10, 2021, which is incorporated herein by reference in its entirety.

### BACKGROUND

Metasurfaces are optical elements to manipulate electromagnetic waves such as light. Metasurfaces may enable various applications that may be impractical to achieve with traditional diffractive lenses. For example, metasurfaces often have a smaller form factor than traditional diffractive lenses and are therefore suited to micro or lightweight applications.

### SUMMARY

One embodiment of the present disclosure is a broadband achromatic metasurface waveplate including a device comprising a plurality of nanostructures physically coupled to a substrate and formed at least partially of a dielectric material having a first refractive index and an anti-reflective film applied to a surface of the device. The anti-reflective film may include a material having a second refractive index that is less than the first refractive index. The device and the anti-reflective film may modify incident light with wavelengths extending over a bandwidth of at least 100 nanometers to impart a substantially uniform phase retardation across the wavelengths and a transmittance of at least 90 percent across the wavelengths.

In some embodiments, the second refractive index is substantially equal to the square root of the product of the first refractive index and a third refractive index. In some embodiments, the wavelengths extend between at least 450 nanometer and 650 nanometer. In some embodiments, the substantially uniform phase retardation varies within a range of 0.08 radians/a. In some embodiments, the dielectric material includes TiO₂ and wherein the material includes Al₂O₃.

Another embodiment of the present disclosure is a metasurface waveplate including a substrate having a first refractive index and a plurality of nanostructures coupled to the substrate and formed at least partially of a dielectric material having a second refractive index. The metasurface waveplate may include a first anti-reflective film positioned between the substrate and the plurality of nanostructures, the first anti-reflective film having a third refractive index that is greater than the first refractive index and less than the second refractive index. The metasurface waveplate may include a second anti-reflective film positioned at least partially on a surface of the plurality of nanostructures, the second anti-reflective film having a fourth refractive index that is less than the second refractive index. The substrate, the plurality of nanostructures, the first anti-reflective film, and the second anti-reflective film may modify incident light with wavelengths extending over a bandwidth of at least 100 nanometers to impart a substantially uniform phase retardation across the wavelengths and a transmittance of at least 90 percent across the wavelengths.

In some embodiments, the third refractive index is substantially equal to the square root of the product of (i) the first refractive index and (ii) an effective index along a slow axis of a device comprising the substrate and the plurality of nanostructures. In some embodiments, the fourth refractive index is substantially equal to the square root of the product of (i) an effective index along a slow axis of a device comprising the substrate and the plurality of nanostructures and (ii) a fifth refractive index. In some embodiments, the wavelengths extend between at least 450 nanometer and 650 nanometer. In some embodiments, the substantially uniform phase retardation varies within a range of 0.08 radians/it. In some embodiments, the dielectric material includes TiO₂ and wherein the first anti-reflective film includes Al₂O₃. In some embodiments, the dielectric material includes TiO₂ and wherein the second anti-reflective film includes Sift.

Another embodiment of the present disclosure is a metasurface waveplate including a device comprising a plurality of nanostructures physically coupled to a substrate having a first refractive index, each nanostructure of the plurality of nanostructures having a radial gradient index centered on the nanostructure, wherein the radial gradient index includes an upper refractive index and a lower refractive index, and wherein the upper refractive index is greater than the first refractive index, wherein device modifies incident light with wavelengths extending over a bandwidth of at least 100 nanometers to impart a substantially uniform phase retardation across the wavelengths and a transmittance of at least 90 percent across the wavelengths.

In some embodiments, the wavelengths extend between at least 450 nanometer and 650 nanometer. In some embodiments, the substantially uniform phase retardation varies within a range of 0.08 radians/it. In some embodiments, the metasurface waveplate further comprises an anti-reflective film applied to a surface of the device, the anti-reflective film comprising a material having a second refractive index that is less than the upper refractive index. In some embodiments, the second refractive index is substantially equal to the square root of the product of (i) a refractive index associated with the plurality of nanostructures and (ii) a third refractive index. In some embodiments, the material includes Al₂O₃. In some embodiments, the radial gradient index comprises a combination of (i) TiO₂ and (ii) at least one of MgF₂ or SiO₂.

Another embodiment of the present disclosure is a method for manufacturing a metasurface waveplate including receiving a description of a gradient index comprising a plurality of refractive indices, determining, according to the description of the gradient index, a plurality of mixtures comprising (i) a first material having a first refractive index and (ii) a second material having a second refractive index that is different than the first refractive index, each of the plurality of mixtures associated with a refractive index of the plurality of refractive indices, and applying, using the plurality of mixtures according to the description of the gradient index, a plurality of film layers on a substrate to achieve the gradient index.

### BRIEF DESCRIPTION OF THE DRAWINGS

For a better understanding of the nature and objects of some embodiments of this disclosure, reference should be made to the following detailed description taken in conjunction with the accompanying drawings.

FIG. 1 is a block diagram illustrating a broadband achromatic metasurface waveplate, according to an example embodiment;

FIG. 2 illustrates optical response characteristics associated with the broadband achromatic metasurface waveplate of FIG. 1, according to an example embodiment;

FIG. 3A is a block diagram illustrating a broadband achromatic metasurface waveplate adapted to include a number of antireflective layers, according to an example embodiment;

FIG. 3B illustrates optical response characteristics associated with the broadband achromatic metasurface waveplate of FIG. 3A, according to an example embodiment;

FIG. 4A is a block diagram illustrating a broadband achromatic metasurface waveplate adapted to include an antireflective coating, according to an example embodiment;

FIG. 4B illustrates optical response characteristics associated with the broadband achromatic metasurface waveplate of FIG. 4A, according to an example embodiment;

FIG. 5A is a block diagram illustrating a broadband achromatic metasurface waveplate adapted to include gradient index elements, according to an example embodiment;

FIG. 5B illustrates optical response characteristics associated with the broadband achromatic metasurface waveplate of FIG. 5A, according to an example embodiment;

FIG. 6A is a block diagram illustrating a broadband achromatic metasurface waveplate adapted to include gradient index elements and an antireflective layer, according to an example embodiment;

FIG. 6B illustrates optical response characteristics associated with the broadband achromatic metasurface waveplate of FIG. 6A, according to an example embodiment;

FIG. 7 is a flowchart illustrating a method of manufacturing a broadband achromatic metasurface waveplate, according to an example embodiment.

### DETAILED DESCRIPTION

Referring now generally to the Figures, described herein are systems and methods of broadband achromatic metasurface waveplates. Waveplates are fundamental optical components that may be used to control optical properties of light such as the polarization state of light. For example, waveplates may be used to generate circularly polarized light, for polarization rotation, and/or for optical isolation. In various embodiments, waveplates are constructed of birefringent materials (e.g., SiO₂, etc.). For example, a quartz waveplate may be used to impart a first phase retardation on light having a first linear polarization orientation and impart a second phase retardation on light having a second linear polarization orientation that is perpendicular to the first linear polarization orientation.

In some embodiments, display devices such as organic light-emitting diode (OLED) displays utilize waveplates. For example, an OLED display may include a waveplate, such as a quarter-wave plate, to control optical properties of the OLED display such as a reflectance of the OLED display. To continue the example, pairing the quarter-wave plate with the OLED display may reduce a reflectance (e.g., back reflectance from the environment) of the OLED display, thereby increasing the visibility of the OLED display. In various embodiments, display devices, such as an OLED display, may operate over broad bandwidth of light such as light with wavelengths extending over a bandwidth of at least 100 nanometers. Therefore, it may be desirable to utilize broadband waveplates (e.g., waveplates that modify a characteristic of light with wavelengths extending over a bandwidth of at least 100 nanometers, etc.) with display devices such as OLED displays.

Moreover, in various embodiments, it may be desirable to utilize achromatic waveplates. Achromatic waveplates may limit the effects of chromatic aberration. For example, achromatic waveplates may focus light of a first wavelength (e.g., 450 nanometers, etc.) and light of a second wavelength (e.g., 650 nanometers, etc.) on substantially the same plane, thereby reducing chromatic distortions caused by differentially focused wavelengths. To continue the example, pairing an achromatic waveplate with a display such as an OLED display may reduce/limit chromatic distortion associated with the combined device (e.g., the OLED display paired with a waveplate, etc.), thereby increasing the visibility and/or accuracy of the OLED display (e.g., as compared with an OLED display including a chromatic waveplate, etc.).

In various embodiments, it is desirable for displays, such as OLED displays, to have high brightness (e.g., luminance). For example, a phone display may have a high brightness to facilitate visibility in high ambient light environments. Therefore, it may be desirable to utilize waveplates having high transmission characteristics. For example, a waveplate having a high transmission rate (e.g., above 90%, etc.) may facilitate passing a large proportion of incident light, thereby reducing environmental reflections and/or limiting dimming a light source such as a display.

Systems and methods of the present disclosure may address these challenges by presenting a metasurface waveplate that operates over a broad bandwidth of light while maintaining a high transmission rate over the bandwidth of light and limiting distortions (e.g., chromatic distortions, etc.) over the bandwidth of light. Additionally, methods of manufacturing a metasurface waveplate are discussed herein. It should be understood that while the broadband achromatic metasurface waveplate of the present disclosure is described in relation to applications within display technology (e.g., pairing with OLED displays, etc.), other possible applications of the broadband achromatic metasurface waveplate of the present disclosure not explicitly mentioned herein are possible and within the scope of the present disclosure.

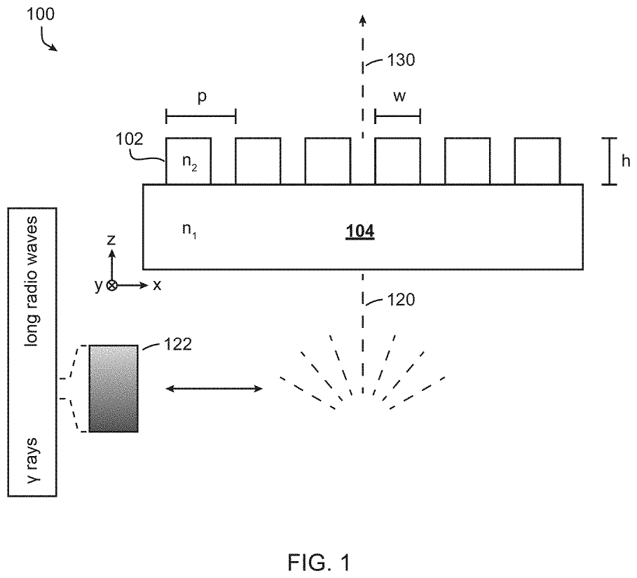

Referring now to FIG. 1, broadband achromatic metasurface waveplate 100 is shown, according to an example embodiment. Speaking generally, waveplate 100 may modify incident light with wavelengths extending over a broad bandwidth to impart a substantially uniform phase retardation (e.g., π/2, π, etc.) across the wavelengths while maintaining a high transmittance across the wavelengths (e.g., an average transmittance of at least 90% across the wavelengths, etc.). As used herein, the term “substantially uniform phase retardation” refers to a phase retardation with less than 5% average error across a bandwidth. For example, a substantially uniform phase retardance may refer to a phase retardance that various within a range of 0.08 radians/it. Similarly, as used herein, the term “achromatic” refers to less than 5% average error across a bandwidth. Moreover, as used herein, the term “broad bandwidth” refers to light with wavelengths extending over a bandwidth of at least 100 nanometers. As used herein, the term “high transmittance” refers to an average transmittance of at least 90% across a bandwidth. In various embodiments, waveplate 100 is usable with displays such as OLED displays to increase a visibility of the displays (e.g., by reducing glare, etc.).

Waveplate 100 is shown to include a number of nanostructures 102 physically coupled to substrate 104. In various embodiments, waveplate 100 is a metasurface waveplate. Speaking generally, a metasurface is a structure having elements (e.g., nanostructures, nanopillars, nanofins, etc.) that are spaced less than the wavelength of the phenomena (e.g., electromagnetic waves such as light, etc.) that the elements influence apart. For example, a metasurface that operates on light having a wavelength of 600 nanometers may include nanopillars that are spaced 100 nanometers apart. In various embodiments, substrate 104 is constructed of a material having a first refractive index (e.g., n₁) and nanostructures 102 are constructed of a material having a second refractive index (e.g., n₂) that is different than the first refractive index. For example, substrate 104 may be constructed of SiO₂ having a refractive index of ˜1.46 across the visible spectrum (e.g., wavelengths in approximately the 450 nanometer to 650 nanometer range, etc.) and nanostructures 102 may be constructed of TiO₂ having a refractive index of ˜2.41 across the visible spectrum. In various embodiments, substrate 104 and nanostructures 102 may be constructed of other materials and/or combinations thereof. For example, nanostructures 102 may be constructed of a spatially varying mix of SiO₂ and TiO₂ (e.g., a gradient index such as a radial gradient index, etc.). As another example, substrate 104 and/or nanostructures 102 may be constructed of CaF₂, Si, Fe, ZnS, and/or ZnSe.

As shown, nanostructures 102 may have a height h, width w, and period p. In various embodiments, waveplate 100 receives incident light 120 having bandwidth 122 and imparts a substantially uniform phase retardation across bandwidth 122 of incident light 120 to produce modified light 130. In various embodiments, modified light 130 has substantially the same intensity as incident light 120. For example, modified light 130 may have an intensity that is 95% of that of incident light 120. In various embodiments, waveplate 100 operates on light with wavelengths extending between 450 nanometers and 650 nanometers. However, it should be understood that waveplate 100 may operate on other wavelengths (e.g., bandwidths, etc.) and that all such embodiments are within the scope of the present disclosure. For example, waveplate 100 may operate on wavelengths extending between 0.8λ and 1.2λ, where λ is a wavelength of interest. In various embodiments, waveplate 100 operates on light in the near-infrared and/or mid-infrared regions. Waveplate 100 may be compact (e.g., substantially ultrathin, etc.) and may exhibit achromaticity at high-incidence angles (e.g., in the presence of high numerical aperture lenses, at angles up to 60°, etc.).

Speaking generally, waveplate 100 may achieve phase retardance using form birefringence (e.g., rather than material birefringence, etc.). In various embodiments, waveplate 100 exhibits different effective refractive indices for linearly polarized light along x- and y-orientations.

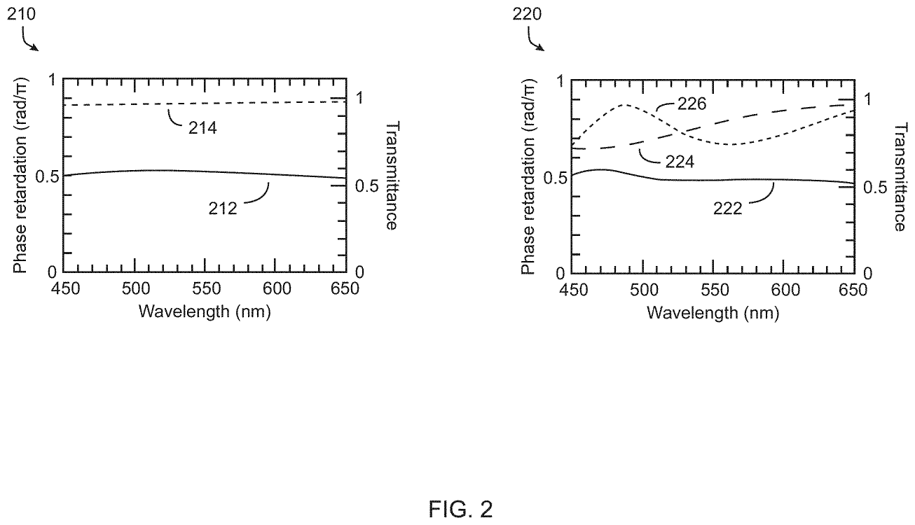

Referring now to FIG. 2, optical response characteristics associated with waveplate 100 are shown, according to an example embodiment. First graph 210 illustrates theoretical performance characteristics associated with a model of waveplate 100 and second graph 220 illustrates measured performance characteristics associated with a manufactured version of waveplate 100. Specifically, first graph 210 includes phase retardation 212 and transmittance 214. Similarly, second graph 210 includes phase retardation 222, x-transmittance 224, and y-transmittance 226.

In various embodiments, first graph 210 corresponds to 400 nanometer (nm) propagation through an infinitely extended TiO₂ waveguide array with p=185 nm and w=130 nm. In various embodiments, height h corresponds to a value that achieves a quarter-wave (π/2) phase retardation between incident x- and y-linearly polarized plane waves. It should be understood that while waveplates of the present disclosure are described in terms of quarter-wave plates, other phase retardation values are possible and fully within the scope of the present disclosure. For example, a broadband achromatic half-wave plate may be designed/fabricated using the systems and methods of the present disclosure (e.g., by doubling a thickness of nanostructures 102, etc.).

In various embodiments, first graph 210 illustrates a substantially flat phase retardation 212 with less than 5% error. Likewise, transmittance 214 may be near-unity and uniform across the spectral range.

In various embodiments, non-idealities may degrade the performance of a practical (e.g., real-world, manufactured, etc.) waveplate when compared with an idealized model of a waveplate. For example, second graph 220 illustrates a reduced transmittance (e.g., x-transmittance 224, y-transmittance 226, etc.) compared with first graph 210 caused at least in part by Fabry-Perot resonances that form within the practical waveplate. Moreover, a practical waveplate may introduce reflections at the substrate-nanostructure interface as well as the nanostructure-air interface due to impedance mismatches. For example, as shown in second graph 220, a practical waveplate may suffer from reduced transmittance. As another example, a practical waveplate may exhibit a transmittance that differs for x- and y-polarizations (e.g., x-transmittance 224, y-transmittance 226, etc.). Systems and methods of the present disclosure may address these challenges. For example, systems and methods of the present disclosure may present anti-reflective elements that facilitate impedance matching and reduce and/or eliminate the performance degradations discussed above.

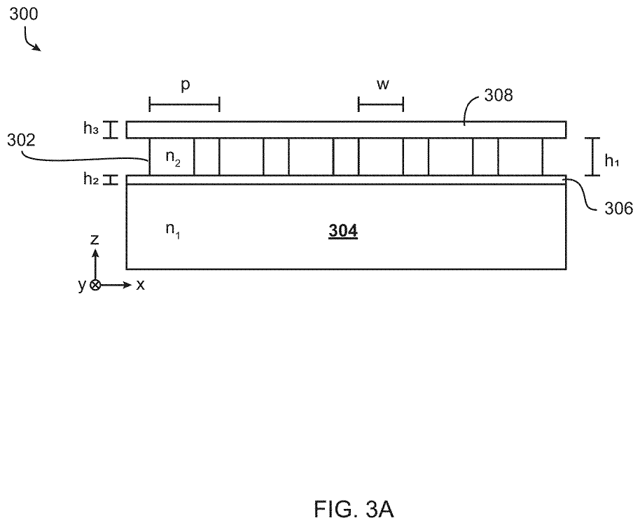

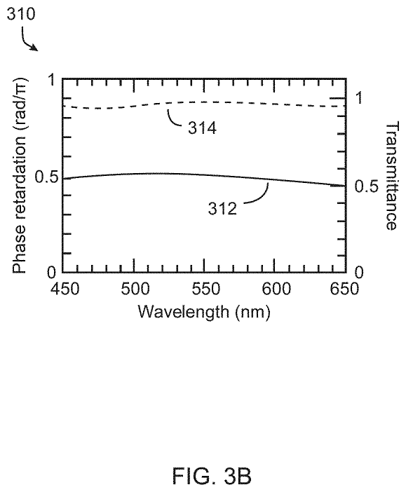

Referring now to FIG. 3A, waveplate 300 is shown, according to an example embodiment. Waveplate 300 may be similar to waveplate 100. For example, waveplate 300 may include a number of nanostructures 302 physically coupled to substrate 304. In various embodiments, waveplate 300 includes first anti-reflective layer 306 and/or second anti-reflective layer 308. First anti-reflective layer 306 may be constructed of a third material having a third refractive index (n₃) and second anti-reflective layer 308 may be constructed of a fourth material having a fourth refractive index (n₄). For example, first anti-reflective layer 306 may be constructed of Al₂O₃ and second anti-reflective layer 308 may be constructed of SiO₂. In various embodiments, n₃ and/or n₄ are determined according to the formula:

n_{AR}=\sqrt{n₁n₂}

where n_{AR} is the refractive index to be determined (e.g., n₃ or n₄, etc.), and n₁ and n₂ are the refractive indices of the adjacent materials (e.g., the material making up substrate 304 and the material making up nanostructures 302 in the case of first anti-reflective layer 306, etc.). For example, if waveplate 300 is surrounded by air then n_{AR} for second anti-reflective layer 308 may be equal to \sqrt{n_{Air}n₂}. However, it should be understood that waveplate 300 may be positioned/integrated within various mediums (e.g., integrated as a layer within a larger device, etc.) and that the choice of anti-reflective material depends upon the surrounding materials. In various embodiments, the materials for first anti-reflective layer 306 and second anti-reflective layer 308 are selected based on the determined refractive indices. For example, n₃ and/or n₄ may be determined as described above and a suitable material may be selected having the determined refractive index values.

In various embodiments, h₁=390 nm, w=130 nm, p=185 nm, h₂=78 nm, and h₃=95 nm. However, it should be understood that the layout and/or dimensions of waveplate 300 may vary depending on application and that all such variations are within the scope of the present disclosure.

In various embodiments, the effective indices at 550 nm for transverse electric (TE) wave modes and transverse magnetic (TM) wave modes in waveplate 300 are n_{TE}=1.8467 and n_{TM}=2.1180 respectively. In various embodiments, first anti-reflective layer 306 is a quarter-stack having a refractive index equal to the effective index of the TE mode (e.g., n₃=n_{TE}). Additionally or alternatively, second anti-reflective layer 308 may be a quarter-stack having a refractive index equal to the effective index of the TM mode (e.g., n₄=n_{TM}). In various embodiments, the inclusion of first anti-reflective layer 306 and/or second anti-reflective layer 308 facilitate mitigating the non-idealities discussed above. For example, first anti-reflective layer 306 and/or second anti-reflective layer 308 may facilitate flattened optical response characteristics and/or increased transmittance (e.g., compared with a waveplate that does not include first anti-reflective layer 306 and/or second anti-reflective layer 308 such as waveplate 100, etc.) as illustrated below with reference to FIG. 3B.

Referring now to FIG. 3B, graph 310 illustrates optical response characteristics of waveplate 300, according to an example embodiment. Similar to first graph 210 and second graph 220, graph 310 is shown to include phase retardation 312 and transmittance 314. As shown in graph 310, waveplate 300 may offer benefits over other systems. For example, waveplate 300 may address at least some of the challenges (e.g., non-idealities, etc.) discussed above. In various embodiments, waveplate 300 exhibits an average transmittance of approximately 97.5%. Moreover, phase retardation 312 and transmittance 314 may be substantially flattened compared with the optical response characteristics of waveplate 100. In various embodiments, waveplate 300 may be desirable in applications that include applying subsequent material to waveplate 300 (e.g., applying material to second anti-reflective layer 308, etc.) because waveplate 300 includes a uniform surface that facilitates the application of additional material (e.g., when compared to the non-uniform surface of nanostructures 102, etc.).

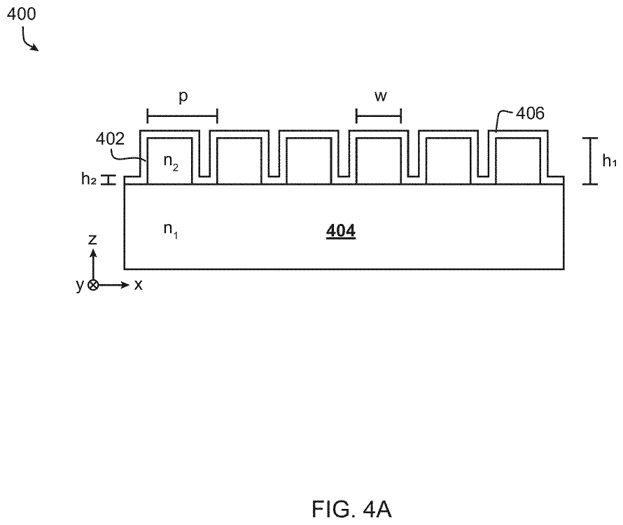

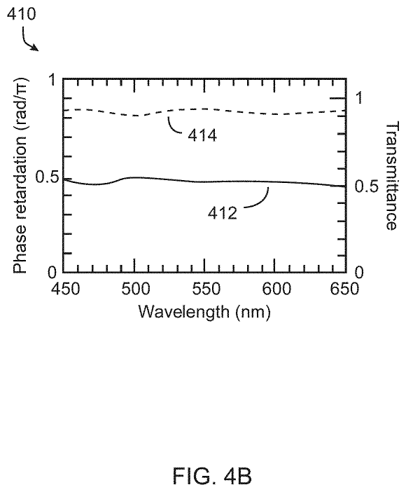

Referring now to FIG. 4A, waveplate 400 is shown, according to an example embodiment. Waveplate 400 may be similar to waveplate 100. For example, waveplate 400 may include a number of nanostructures 402 physically coupled to substrate 404. In various embodiments, waveplate 400 includes anti-reflective film 406. Anti-reflective film 406 may be applied to a surface of nanostructures 402 and/or substrate 404. Anti-reflective film 406 may be constructed of a third material having a third refractive index (n₃). For example, anti-reflective film 406 may be constructed of Al₂O₃. In some embodiments, anti-reflective film 406 is constructed of a material having a refractive index determined according to the equation:

$${n}_{AR} = \sqrt{\frac{{n}_{eff , x} + {n}_{eff , y}}{2} * {n}_{e mbedding}}$$

where n_{eff, x} is an effective refractive index of nanostructures 402 in the x-direction, n_{eff, y} is an effective refractive index of nanostructures 402 in the y-direction, and n_{embedding} is an refractive index of an embedding material (e.g., air, etc.). In various embodiments, anti-reflective film 406 has a uniform thickness (e.g., height, etc.). Anti-reflective film 406 may at least partially reduce reflections at an interface of waveplate 400, thereby flattening the optical response characteristics of waveplate 400 and/or increasing a transmittance associated with waveplate 400 (e.g., when compared with a waveplate that does not include anti-reflective film 406 such as waveplate 100, etc.).

In various embodiments, w=100 nm, h₁=760 nm, p=200 nm, and h₂=40 nm. However, it should be understood that the layout and/or dimensions of waveplate 400 may vary depending on application and that all such variations are within the scope of the present disclosure.

In various embodiments, the inclusion of anti-reflective film 406 facilitates mitigating the non-idealities discussed above. For example, anti-reflective film 406 may facilitate flattened optical response characteristics and/or increased transmittance (e.g., compared with a waveplate that does not include anti-reflective film 406 such as waveplate 100, etc.) as illustrated below with reference to FIG. 4B.

Referring now to FIG. 4B, graph 410 illustrates optical response characteristics of waveplate 400, according to an example embodiment. Similar to first graph 210 and second graph 220, graph 410 is shown to include phase retardation 412 and transmittance 414. As shown in graph 410, waveplate 400 may offer benefits over other systems. For example, waveplate 400 may address at least some of the challenges (e.g., non-idealities, etc.) discussed above. In various embodiments, waveplate 400 exhibits an average transmittance of 93%. Moreover, phase retardation 412 and transmittance 414 may be substantially flattened compared with the optical response characteristics of waveplate 100. In various embodiments, waveplate 400 may be desirable in applications that require simplicity in fabrication. For example, waveplate 400 may save a fabrication step compared with the sandwich structure of waveplate 300.

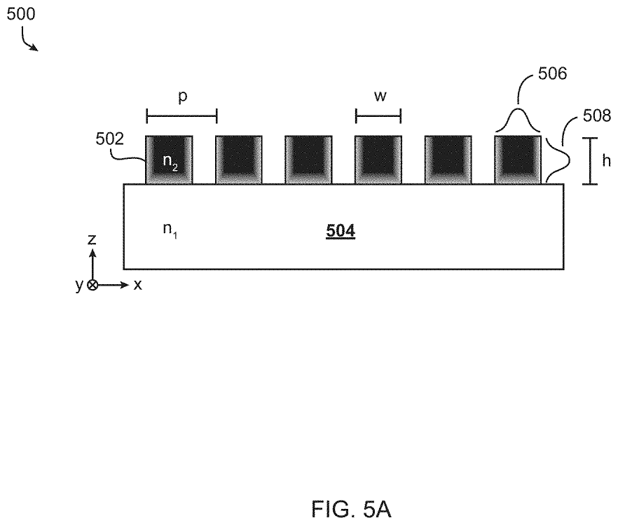

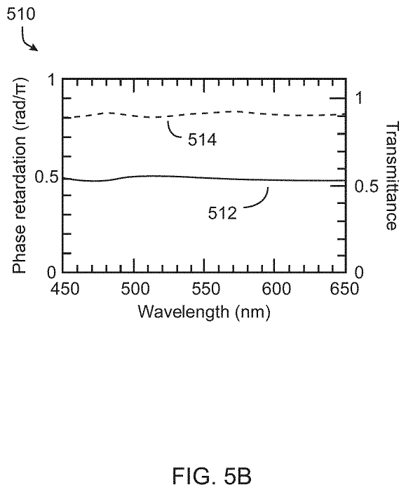

Referring now to FIG. 5A, waveplate 500 is shown, according to an example embodiment. Waveplate 500 may be similar to waveplate 100. For example, waveplate 500 may include a number of nanostructures 502 physically coupled to substrate 504. Nanostructures 502 may have a spatially-varying refractive index (e.g., a gradient index, etc.). For example, nanostructures 502 may have a gradient index with a Gaussian profile within each of nanostructures 502. In various embodiments, the refractive index of nanostructures 502 has an x-profile 506 and a y-profile 508. For example, the refractive index of each of nanostructures 502 may have a spatially-varying profile that resembles a Gaussian distribution in the x-direction (e.g., x-profile 506) and a bimodal distribution in the y-direction (e.g., y-profile 508). In various embodiments, the refractive index of nanostructures 502 is highest at a center of each of nanostructures 502 and reduces towards the edges of each of nanostructures 502 (e.g., towards the bottom and sides of each of the nanostructures, etc.). In various embodiments, the spatially-varying refractive index of each of nanostructures 502 is determined according to the formula:

$$n ( d ) = {n}_{1} + ( {n}_{2} - {n}_{1} ) * {e}^{{( \frac{- d}{0.2 ⋆ 0.5 w} )}^{2}}$$

where d is a distance from the side and bottom (e.g., the interface between nanostructures 502 and substrate 504) of each of nanostructures 502 to the center of each of nanostructures 502. In various embodiments, n₁=1.90 and n₂=2.41. In various embodiments, nanostructures 502 are constructed of a combination of TiO₂ and SiO₂. For example, TiO₂ and SiO₂ may be combined in different ratios to produce a number of amalgams having different refractive indices. In some embodiments, nanostructures 502 are constructed having a continuous gradient of refractive indices. Additionally or alternatively, nanostructures 502 may be constructed with stepwise refractive indices.

In various embodiments, w=180 nm, p=235 nm, and h=780 nm. However, it should be understood that the layout and/or dimensions of waveplate 500 may vary depending on application and that all such variations are within the scope of the present disclosure.

In various embodiments, the use of a gradient index in nanostructures 502 facilitates mitigating the non-idealities discussed above. For example, the gradient index may facilitate flattened optical response characteristics and/or increased transmittance (e.g., compared with a waveplate that does not include a gradient index such as waveplate 100, etc.) as illustrated below with reference to FIG. 5B.

Referring now to FIG. 5B, graph 510 illustrates optical response characteristics of waveplate 500, according to an example embodiment. Similar to first graph 210 and second graph 220, graph 510 is shown to include phase retardation 512 and transmittance 514. As shown in graph 510, waveplate 500 may offer benefits over other systems. For example, waveplate 500 may address at least some of the challenges (e.g., non-idealities, etc.) discussed above. In various embodiments, waveplate 500 exhibits an average transmittance of 92%. Moreover, phase retardation 512 and transmittance 514 may be substantially flattened compared with the optical response characteristics of waveplate 100. The gradient index of nanostructures 502 may at least partially reduce reflections Fabry-Perot resonances, thereby flattening the optical response characteristics of waveplate 500 and/or increasing a transmittance associated with waveplate 500 (e.g., when compared with a waveplate that does not include nanostructures 502 having a gradient index such as waveplate 100, etc.).

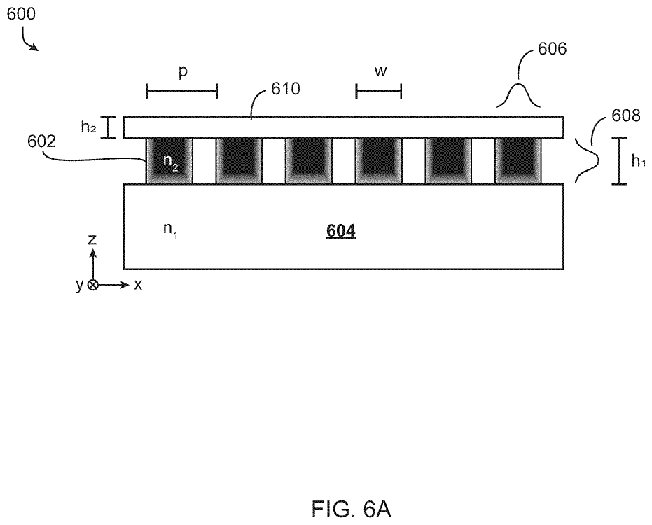

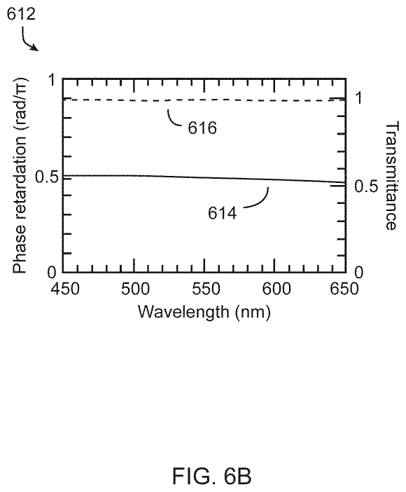

Referring now to FIG. 6A, waveplate 600 is shown, according to an example embodiment. Waveplate 600 may be similar to waveplate 500. For example, waveplate 600 may include a number of nanostructures 602 physically coupled to substrate 604. Additionally, nanostructures 602 may have a spatially-varying refractive index (e.g., a gradient index, etc.). For example, nanostructures 602 may have a gradient index with x-profile 606 and y-profile 608. In various embodiments, waveplate 600 includes anti-reflective layer 610. Anti-reflective layer 610 may be constructed of a third material having a third refractive index (n₃). For example, anti-reflective layer 610 may be constructed of Al₂O₃.

In various embodiments, w=180 nm, p=235 nm, h₁=780 nm, and h₂=90 nm. However, it should be understood that the layout and/or dimensions of waveplate 600 may vary depending on application and that all such variations are within the scope of the present disclosure.

In various embodiments, the inclusion of anti-reflective layer 610 facilitates mitigating the non-idealities discussed above. For example, anti-reflective layer 610 may facilitate flattened optical response characteristics and/or increased transmittance (e.g., compared with a waveplate that does not include anti-reflective layer 610 such as waveplate 500, etc.) as illustrated below with reference to FIG. 6B.

Referring now to FIG. 6B, graph 612 illustrates optical response characteristics of waveplate 600, according to an example embodiment. Similar to first graph 210 and second graph 220, graph 612 is shown to include phase retardation 614 and transmittance 616. As shown in graph 612, waveplate 600 may offer benefits over other systems. For example, waveplate 600 may address at least some of the challenges (e.g., non-idealities, etc.) discussed above. In various embodiments, waveplate 600 exhibits an average transmittance of 99% (e.g., across the 450 nm to 650 nm range). Moreover, phase retardation 614 and transmittance 616 may be substantially flattened compared with the optical response characteristics of waveplate 100. The gradient index of nanostructures 602 may at least partially reduce reflections Fabry-Perot resonances, thereby flattening the optical response characteristics of waveplate 600 and/or increasing a transmittance associated with waveplate 600 (e.g., when compared with a waveplate that does not include nanostructures 602 having a gradient index such as waveplate 100, etc.).

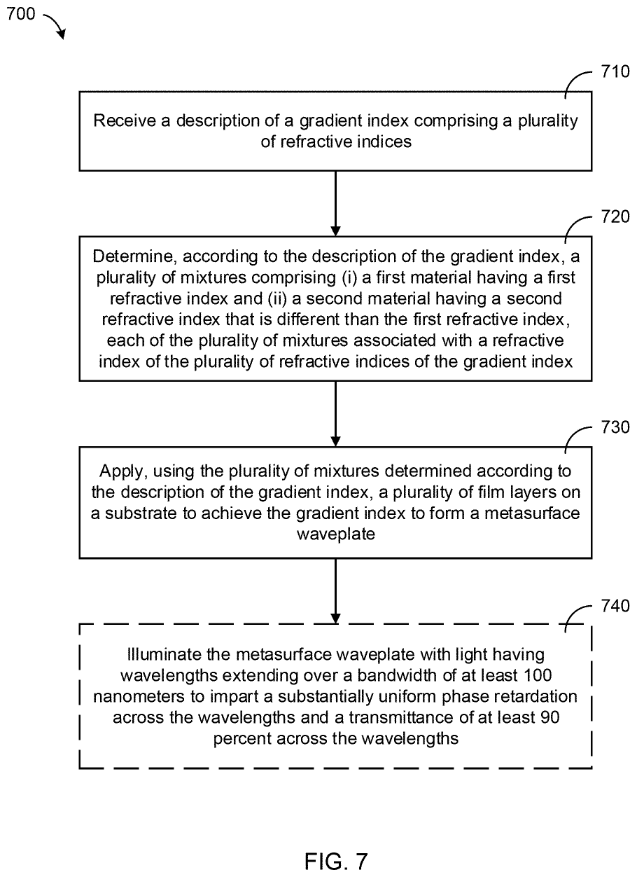

Referring now to FIG. 7, method 700 of manufacturing a broadband achromatic metasurface waveplate is shown, according to an example embodiment. In various embodiments, method 700 is used to fabricate waveplate 500 and/or waveplate 600. For example, method 700 may facilitate manufacturing a waveplate having a gradient index profile.

In various embodiments, method 700 is implemented by a computing system such as a processing circuit having a processor and memory. For example, method 700 may be implemented as non-transitory computer-readable instructions that are executed by a processing circuit to cause the processing circuit to perform the various operations described herein. The operations described herein may be implemented using software, hardware, or a combination thereof. A processing circuit may include a microprocessor, ASIC, FPGA, etc., or combinations thereof. In many embodiments, a processing circuit may include a multi-core processor or an array of processors. Memory may include, but is not limited to, electronic, optical, magnetic, or any other storage devices capable of providing the processor with program instructions. Memory may include a floppy disk, CDROM, DVD, magnetic disk, memory chip, ROM, RAM, EEPROM, EPROM, flash memory, optical media, or any other suitable memory from which the processor can read instructions. The instructions may include code from any suitable computer programming language such as, but not limited to, C, C++, C#, Java, JavaScript, Perl, HTML, XML, Python and Visual Basic.

At step 710, a processing circuit may receive a description of a gradient index comprising a number of refractive indices. For example, the processing circuit may receive a computer-aided design (CAD) file describing a waveplate similar to waveplate 500 and including a number of nanostructures each having a spatially-varying refractive index profile (e.g., a gradient index, etc.). In some embodiments, the gradient index is a continuous gradient index (e.g., varying continuously from a center of a nanostructure to an edge of the nanostructure, etc.). Additionally or alternatively, the gradient index may be a stepwise gradient index (e.g., varying in steps from a center of a nanostructure to an edge of the nanostructure, etc.). For example, the gradient index may include 3 steps.

At step 720, the processing circuit may determine, according to the description of the gradient index, a number of mixtures comprising (i) a first material having a first refractive index and (ii) a second material having a second refractive index that is different than the first refractive index. For example, step 720 may include combining pre-cursors for TiO₂ and SiO₂ in varying ratios. As another example, step 720 may include combining pre-cursors for TiO₂ and MgF₂ in varying ratios. In various embodiments, each of the number of mixtures is associated with a refractive index of the number of refractive indices of the gradient index. For example, step 720 may include determining a mixture of TiO₂ and SiO₂ that achieves each of the number of refractive indices.

At step 730, the processing circuit may apply, using the number of mixtures, a number of film layers on a substrate to achieve the gradient index. For example, step 730 may include combining the pre-cursors of (i) TiO₂ and (ii) at least one of MgF₂ or SiO₂ in varying ratios during each deposition loop of an electronbeam lithography process to achieve the desired gradient index (e.g., via Maxwell-Garnett material mixtures of TiO₂ and SiO₂, etc.). It should be understood that while method 700 is described in relation to TiO₂ and SiO₂, any materials may be used and all such variations are within the scope of the present disclosure. In various embodiments, step 730 includes applying the film layers sequentially (e.g., one on top of another, etc.) while varying the material mixtures within each film layer and between film layers to achieve the desired x- and y-profiles (e.g., x-profile 606 and y-profile 608, etc.). Additionally or alternatively, step 730 may include fabricating each nanostructure (e.g., such as nanostructures 402, etc.) and subsequently applying layers around each nanostructure to achieve the gradient index (e.g., via backfill, etc.).

At step 730, the metasurface waveplate may be illuminated with light having wavelengths extending over a bandwidth of at least 100 nm. The waveplate may impart a substantially uniform phase retardation across the wavelengths. For example, the waveplate may impart a phase retardation that varies within a range of 0.08 radians/it. Additionally or alternatively, the waveplate may exhibit a transmittance of at least 90% across the wavelengths. In various embodiments, step 730 is optional. In various embodiments, the waveplate is integrated into a device such as a smartphone display. However, it should be understood that the waveplate may be integrated into any device that would benefit from the optical response characteristics of the waveplate and that all such embodiments are within the scope of the present disclosure.

As used herein, the terms “approximately,” “substantially,” “substantial” and “about” are used to describe and account for small variations. When used in conjunction with an event or circumstance, the terms can refer to instances in which the event or circumstance occurs precisely as well as instances in which the event or circumstance occurs to a close approximation. For example, when used in conjunction with a numerical value, the terms can refer to a range of variation less than or equal to ±10% of that numerical value, such as less than or equal to ±5%, less than or equal to ±4%, less than or equal to ±3%, less than or equal to ±2%, less than or equal to ±1%, less than or equal to ±0.5%, less than or equal to ±0.1%, or less than or equal to ±0.05%. For example, two numerical values can be deemed to be “substantially” the same or equal to each other if a difference between the values is less than or equal to ±10% of an average of the values, such as less than or equal to ±5%, less than or equal to ±4%, less than or equal to ±3%, less than or equal to ±2%, less than or equal to ±1%, less than or equal to ±0.5%, less than or equal to ±0.1%, or less than or equal to ±0.05%.

While the present disclosure has been described and illustrated with reference to specific embodiments thereof, these descriptions and illustrations do not limit the present disclosure. It should be understood by those skilled in the art that various changes may be made and equivalents may be substituted without departing from the true spirit and scope of the present disclosure as defined by the appended claims. The illustrations may not be necessarily drawn to scale. There may be distinctions between the artistic renditions in the present disclosure and the actual apparatus due to manufacturing processes and tolerances. There may be other embodiments of the present disclosure which are not specifically illustrated. The specification and drawings are to be regarded as illustrative rather than restrictive. Modifications may be made to adapt a particular situation, material, composition of matter, method, or process to the objective, spirit and scope of the present disclosure. All such modifications are intended to be within the scope of the claims appended hereto. While the methods disclosed herein have been described with reference to particular operations performed in a particular order, it will be understood that these operations may be combined, sub-divided, or re-ordered to form an equivalent method without departing from the teachings of the present disclosure. Accordingly, unless specifically indicated herein, the order and grouping of the operations are not limitations of the present disclosure.

What is claimed is:

1. A broadband achromatic metasurface waveplate, comprising:
a device comprising a plurality of nanostructures physically coupled to a substrate and formed at least partially of a dielectric material having a first refractive index; and
an anti-reflective film applied to a surface of the device, the anti-reflective film comprising a material having a second refractive index that is less than the first refractive index; and
wherein the device and the anti-reflective film modify incident light with wavelengths extending over a bandwidth of at least 0.8λ to 1.2λ, to impart a substantially uniform phase retardation across the wavelengths, and a transmittance of at least 90 percent across the wavelengths.

2. The broadband achromatic metasurface waveplate of claim 1, wherein the second refractive index is substantially equal to the square root of the product of the first refractive index and a third refractive index.

3. The broadband achromatic metasurface waveplate of claim 1, wherein the wavelengths extend between at least 450 nanometer and 650 nanometer.

4. The broadband achromatic metasurface waveplate of claim 1, wherein the substantially uniform phase retardation varies within a range of 0.08 radians/π.

5. The broadband achromatic metasurface waveplate of claim 1, wherein the dielectric material includes TiO₂ and wherein the material includes Al₂O₃.

6. A metasurface waveplate, comprising:
a substrate having a first refractive index;
a plurality of nanostructures coupled to the substrate and formed at least partially of a dielectric material having a second refractive index;
a first anti-reflective film positioned between the substrate and the plurality of nanostructures, the first anti-reflective film having a third refractive index that is greater than the first refractive index and less than the second refractive index; and
a second anti-reflective film positioned at least partially on a surface of the plurality of nanostructures, the second anti-reflective film having a fourth refractive index that is less than the second refractive index; and
wherein the substrate, the plurality of nanostructures, the first anti-reflective film, and the second anti-reflective film modify incident light with wavelengths extending over a bandwidth of at least 0.8λ to 1.2λ to impart a substantially uniform phase retardation across the wavelengths and a transmittance of at least 90 percent across the wavelengths.

7. The metasurface waveplate of claim 6, wherein the third refractive index is substantially equal to the square root of the product of (i) the first refractive index and (ii) an effective index along a slow axis of a device comprising the substrate and the plurality of nanostructures.

8. The metasurface waveplate of claim 6, wherein the fourth refractive index is substantially equal to the square root of the product of (i) an effective index along a slow axis of a device comprising the substrate and the plurality of nanostructures and (ii) a fifth refractive index.

9. The metasurface waveplate of claim 6, wherein the wavelengths extend between at least 450 nanometer and 650 nanometer.

10. The metasurface waveplate of claim 6, wherein the substantially uniform phase retardation varies within a range of 0.08 radians/π.

11. The metasurface waveplate of claim 6, wherein the dielectric material includes TiO₂ and wherein the first anti-reflective film includes Al₂O₃.

12. The metasurface waveplate of claim 6, wherein the dielectric material includes TiO₂ and wherein the second anti-reflective film includes SiO₂.

13. A metasurface waveplate, comprising:
a device comprising a plurality of nanostructures physically coupled to a substrate having a first refractive index, each nanostructure of the plurality of nanostructures having a radial gradient index centered on the nanostructure, wherein the radial gradient index includes an upper refractive index and a lower refractive index, and wherein the upper refractive index is greater than the first refractive index; and
wherein device modifies incident light with wavelengths extending over a bandwidth of at least 0.8λ to 1.2λ to impart a substantially uniform phase retardation across the wavelengths and a transmittance of at least 90 percent across the wavelengths.

14. The metasurface waveplate of claim 13, wherein the wavelengths extend between at least 450 nanometer and 650 nanometer.

15. The metasurface waveplate of claim 13, wherein the substantially uniform phase retardation varies within a range of 0.08 radians/π.

16. The metasurface waveplate of claim 13, further comprising an anti-reflective film applied to a surface of the device, the anti-reflective film comprising a material having a second refractive index that is less than the upper refractive index.

17. The metasurface waveplate of claim 16, wherein the second refractive index is substantially equal to the square root of the product of (i) a refractive index associated with the plurality of nanostructures and (ii) a third refractive index.

18. The metasurface waveplate of claim 16, wherein the material includes Al₂O₃.

19. The metasurface waveplate of claim 13, wherein the radial gradient index comprises a combination of (i) TiO₂ and (ii) at least one of MgF₂ or SiO₂.
